(19) United States
(12) Patent Application Publication
(10) Pub. No.: US 2010/0220302 A1
(43) Pub. Date: Sep. 2, 2010

(54) PROJECTION EXPOSURE APPARATUS FOR SEMICONDUCTOR LITHOGRAPHY COMPRISING A COOLING DEVICE

(75) Inventor: Roland Gischa, Elchingen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/711,993

(22) Filed: Feb. 24, 2010

(30) Foreign Application Priority Data
Feb. 27, 2009 (DE) 102009010719.3

(51) Int. Cl. G03B 27/52

(52) U.S. Cl. 355/30

(57) ABSTRACT

A projection exposure apparatus for semiconductor lithography includes a cooling device for cooling components of the projection exposure apparatus. The cooling device contains a liquid cooling medium having a thermal conductivity of greater than 5W/mK.

### CROSS-REFERENCE TO RELATED APPLICATION

This application claims priority to German patent application 10 2009 010 719.3, filed Feb. 27, 2009, the entire contents of which are hereby incorporated by reference.

### FIELD

The disclosure relates to a projection exposure apparatus for semiconductor lithography including a cooling device for cooling components of the projection exposure apparatus.

### BACKGROUND

In projection exposure apparatuses for semiconductor lithography, integrated circuits are produced on a semiconductor substrate, a so-called wafer, by the desired structures firstly being produced on a mask, a so-called reticle. Afterward, the structures are imaged, generally in demagnified fashion, on the wafer via an imaging optical unit, a so-called projection objective. Radiation from the visible, ultraviolet or extreme ultraviolet wavelength range is usually used for the imaging. The comparatively high intensities of the radiation used have the effect that the optical components used for imaging or beam shaping in the projection exposure apparatus are heated considerably. This arises in particular in the cases in which the radiation used for imaging occupies the ultraviolet or extreme ultraviolet wavelength range. Particularly in the extreme ultraviolet wavelength range, the so-called EUV wavelength range, for imaging purposes it is not possible to use transmissive optical elements, such as, for example, lenses or the like, rather it is desirable to use reflective optical elements, usually so-called multilayer mirrors such that, for the wavelength range mentioned, the beam shaping or beam guiding or the imaging is effected exclusively with regard to reflection. However, the mirrors used exhibit a high degree of absorption for the wavelengths employed, such that they are heated greatly under the action of the electromagnetic radiation mentioned. Since the heating mentioned leads to thermal expansion of the mirror material, the imaging quality of the projection exposure apparatus cannot be maintained without additional measures. For this reason it is desirable to cool mirrors for an EUV projection objective, in particular. For this purpose, by way of example, a gas flow or else conventional water cooling can be used, but the cooling concepts used regularly cause constructional challenges with regard to the structural space taken up and with regard to the vibrations and thus disturbances introduced into the projection objective by the cooling system.

### SUMMARY

In some embodiments, the disclosure provides a projection exposure apparatus for semiconductor lithography which has a cooling device for its optical elements or other components with increased efficiency.

The cooling device can contain a liquid cooling medium having a thermal conductivity of greater than 5 W/mK. This choice of the thermal conductivity can have the advantage that the heat transfer from the component to be cooled to the cooling medium can take place considerably more efficiently than would be the case when using, for example, water as the cooling medium. The improved heat transfer can be exploited by virtue of the fact that, for example, the velocity at which the cooling medium flows past a component region to be cooled can be reduced by comparison with conventional solutions. The reduction of the flow velocity then has the consequence that the disturbing introduction of mechanical vibrations which can originate from movements such as, for example, turbulences in the cooling medium is reduced. In certain cases, the flow parameters of the cooling medium can be chosen such that a substantially laminar flow, i.e. a largely turbulence-free flow, is present in the region of the component to be cooled. Furthermore, the possibility of working with lower pressures of the cooling medium is available, such that the deformations of the optical elements to be cooled on account of the pressure of the cooling medium can be reduced.

Moreover, the high thermal conductivity of the cooling medium also allows the heat taken up from the components to be efficiently transported away in an external cooling unit. In other words, the cooling medium itself can also be cooled better.

In addition or as an alternative, it is possible for the lines through which the cooling liquid is conveyed to be relatively small. Heat transfer surfaces, by which the heat is dissipated from the component to be cooled, can be configured with a simpler geometry. These measures can have the effect that the structural space involved for the cooling device is reduced.

Conversely, the use of the cooling liquid having the properties according to the disclosure in a conventionally dimensioned or designed cooling device can lead to a considerable increase in performance by comparison with the operation of the cooling device using water, for example.

The above-described increase in the efficiency of the cooling device can have the advantage that thermally induced mechanical deformations and impairment of the associated projection exposure apparatus can be avoided as a result of the heat being rapidly transported away from the component to be cooled.

The cooling medium can be a liquid metal or a liquid metal alloy, such as one containing one or more of the elements gallium, indium and tin.

In some embodiments, an alloy has 55% and 75% gallium, between 18% and 24% indium, and 14% and 18% tin.

An alloy containing 68.5% gallium, 21.5% indium and 10% tin is available under the trade name Galinstan. The alloy has its melting point at −19° C. and its boiling point at a temperature >1300° C. This means that it is stable in the liquid phase practically over the entire operating temperature range of a projection exposure apparatus, which considerably improves the handlability of the cooling device. It is also well suited to use in a high vacuum. With deviations from the stated percentage composition, the stated parameters shift correspondingly, such that the alloy can be adapted optimally toward the envisioned field of use. With restrictions, the advantages mentioned above apply to practically all liquid metals or liquid metal alloys.

An electromagnetic pump can advantageously be employed for conveying the cooling medium. Pumps of this type utilize a strong magnetic field for conveying liquid metals and are distinguished in particular by the fact that they can be operated largely without moving parts. More detailed explanations concerning pumps of this type and their construction principles may be found in the journal “Electrical Engineering (Archiv für Elektrotechnik)”, Springer Berlin/Heidelberg, Volume 70, Number 2/March 1987, pages 129-135. In this case, the use of the pumps mentioned ensures the effective reduction of mechanical disturbances as a result of influences of the pumps used. Moreover, the pumps mentioned are distinguished by the fact that they take up a small structural space. The properties mentioned have the effect that the constructional possibilities in the realization of a cooling device according to the disclosure, are extended by virtue of the fact that a large number of possibilities arise for the installation location of the pump since the restrictions associated with the pump with regard to mechanical disturbances and structural space taken up are considerably reduced compared with the use of conventional mechanical pumps.

The solutions disclosed herein can be used practically for cooling any desired components of a projection exposure apparatus, such as optical elements (e.g., lenses or mirrors), but also for the mounts of optical elements, parts of an illumination device, parts of the projection objective, actuators or sensors.

On account of the high thermal loads, the solution is appropriate in particular for use in an EUV projection exposure apparatus where its increased efficiency is manifested in a particularly advantageous manner.

Here the solution can be used, for example, with regard to regions/volumes of a projection objective that are spatially separated from one another, so-called compartments, not only to shield them from contamination but also to thermally insulate them from one another. The compartments can contain a plurality of optical elements or else just a single optical element. In the latter case, the compartments - particularly when a minimized spatial region around the spatial region through which a projection beam passes is delimited by the compartment—are also referred to as “mini-environment”. The shielding can be achieved via a separating structure which is realized as a wall and which can also be used as supporting structure for further components of the apparatus. This separating structure can then be cooled or temperature-regulated by the cooling device according to the disclosure. The thermal isolation of compartments with respect to one another can also be employed for projection exposure apparatuses for higher wavelength ranges than EUV, which use transmissive optical elements.

### BRIEF DESCRIPTION OF THE DRAWINGS

The disclosure is explained in greater detail below with reference to the drawing, in which:

FIG. 1 shows a first exemplary embodiment of the disclosure,

FIG. 2 shows a basic schematic diagram serving to elucidate the physical principle on which the disclosure is based,

FIG. 3 shows a projection exposure apparatus for semiconductor lithography,

FIG. 4 shows a first variant for regulating the temperature of a separating structure; and

FIG. 5 shows a further possibility for regulating the temperature of a separating structure.

### DETAILED DESCRIPTION

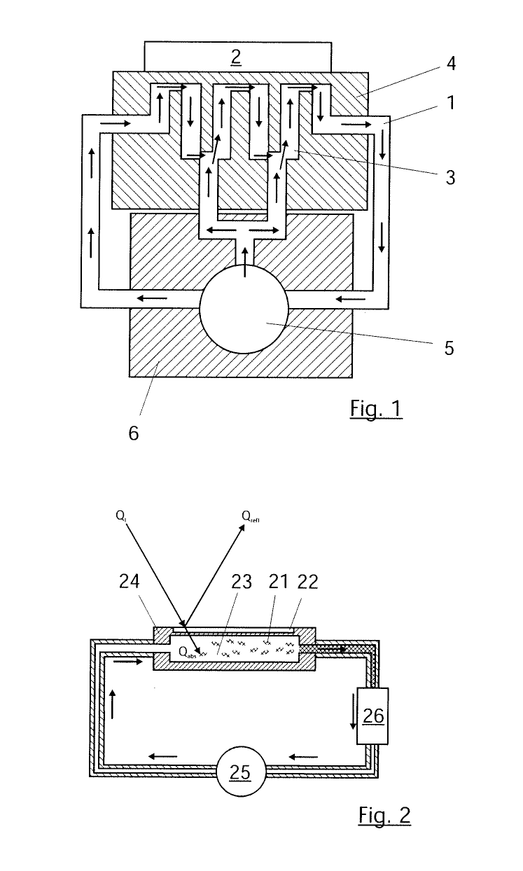

FIG. 1 shows an exemplary embodiment of the disclosure in which the component 2 to be cooled is realized as an optical element, in particular as a mirror on a carrier structure 4. The mirror 2 can be, for example, a mirror in a projection exposure apparatus for EUV lithography. The cooling channel 3, runing in a meandering fashion in sections, is introduced in the carrier structure 4. The cooling medium 1 flows through the cooling channel 3. The cooling medium 1 is formed as an alloy composed of, for example, gallium (Ga), indium (In) and tin (Sn). Other liquid metals or alloys may be used, such as ones including one or more of the following elements: bismuth (Bi); lithium (Li); sodium (Na); potassium (K); rubidium (Rb); cesium (Cs); gallium (Ga); indium (In); tin (Sn) and mercury (Hg). The liquid is conveyed through the cooling channels 3 by a pump 5, which is an electromagnetic pump. In this case, the cooling channels 3 are formed in the carrier structure 4 in such a way that, in the region that adjoins the region of the optical element 2 which is to be cooled, two inflows of the cooling medium 1 serving for cooling are realized, as can be discerned on the basis of the flow direction indicated by the arrows. Guiding of the cooling medium 1 in the manner shown has the effect that from left to right, as illustrated in FIG. 2, the temperature gradient due to the heating of the cooling medium 1 is effectively limited, such that mechanical deformations of the carrier structure 4 and thus of the optical element 2 which originating from the temperature gradient are effectively reduced. In the example illustrated, a cooling unit 6 is provided in the region of the pump 5. The cooling unit 6 can be formed as conventional water cooling. Other types of cooling of the cooling medium 1 are also conceivable. As an alternative to the illustrated embodiment of the disclosure, the optical element 2 can also be provided directly with coolant channels 3 through which the cooling medium 1 flows.

The physical principle on which the disclosure is based will be explained below with reference to FIG. 2. FIG. 2 shows a schematic illustration of the device according to the disclosure. It essentially shows the optical element 22 integrated in the supporting structure 24, the cooling medium 21 flowing through the supporting structure 24 in the arrow direction. In this case, the supporting structure 24 exhibits the cooling channel 23 formed as a contiguous, for example parallelepipedal, space. The cooling medium 21 enters into the cooling channel 23, is heated at the interface between the cooling channel 23 and those regions of the supporting structure 24 which are adjacent to the optical element 22, and subsequently flows through the cooling unit 26 where the heat taken up from the optical element 22 is withdrawn again from the cooling medium 21. In this case, the cooling medium 21 is conveyed by the pump 25. In principle, the heat flow Q₁ incident on the optical element 22 is split into the two partial heat flows Q_{refl} and Q_{abs}, where Q_{refl} is the heat flow reflected at the optical element 22 and Q_{abs} represents the heat flow which is absorbed by the optical element 22 and which is subsequently intended to be emitted to the cooling medium 21. In this case, the cooling unit 26 is desirably configured in such a way that Q_{abs} can be dissipated from the cooling medium 21. In principle, the efficiency of the cooling system is measured according to the extent to which Q_{abs} can be taken up by the cooling medium 21 and be dissipated from the region in the vicinity of the optical element 22. With regard to the cooling medium 21, in general, the specific heat capacity c and the thermal conductivity λ of the cooling medium 21 are important physical parameters.

In this case, the quantity of heat which is transferred from the optical element 22 into the cooling medium 21 during the time t is calculated according to the formula:

Q=αA·t·ΔT

where Q is the quantity of heat which crosses the interface with the area content A in the time t;

$$α = \frac{λ}{{δ}_{T}}$$

is the local heat transfer coefficient;

λ is the specific thermal conductivity; and

δ_{T} is the thickness of the thermal boundary layer.

The specified relationship holds true assuming a laminar flow of the cooling medium 21 along the interface.

In this case, the heat transfer is based primarily on heat conduction through the thermal boundary layer. In this case, the thermal boundary layer runs from the region of the interface in the direction of the cooling medium flowing past to that distance from the interface starting from which the temperature in the direction of the interior of the cooling medium remains constant.

From the relationship presented above it immediately becomes clear that the quantity of heat which passes through the interface per unit time is linearly dependent on the thermal conductivity λ of the cooling medium 21. Cooling media with large λ thus allow a higher quantity of heat Q to be transferred in a predetermined time or, for a predetermined quantity of heat, the time t involved for cooling to be shortened. This has the effect that, for efficient cooling, it is not absolutely necessary to increase ΔT, that is to say the temperature difference between optical element 22 and cooling medium 21, rather it suffices, as an alternative solution, to choose a cooling medium with large λ.

On account of the good thermal conductivity of the cooling medium used, the simple geometry of the cooling channel 23 as illustrated in FIG. 2 can be employed in real arrangements. It is advantageous here that the simple geometry mentioned reduces the risk of turbulences and thus of the introduction of disturbing mechanical vibrations into the optical element.

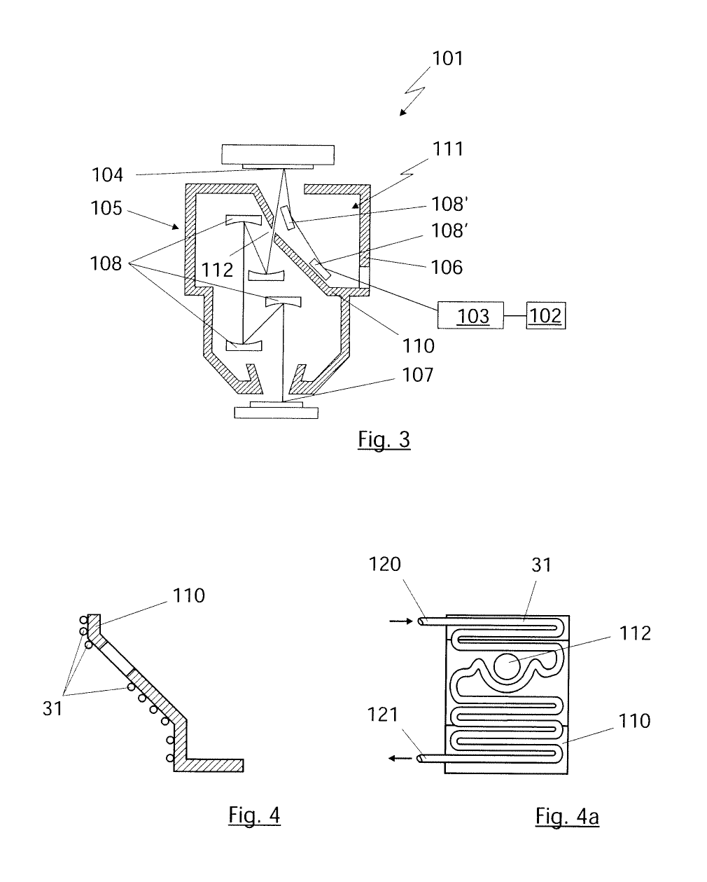

FIG. 3 illustrates an EUV projection exposure apparatus 101 in which the disclosure can be employed. It contains a light source 102, an EUV illumination system 103 for illuminating a field in an object plane 104 in which a structure-bearing mask (not illustrated), is arranged, and also a projection objective 105 having a housing 106, and a beam path for imaging the mask arranged in the object plane 104 onto a light-sensitive substrate 107 for the production of semiconductor components. The projection objective 105 has optical elements formed as mirrors 108 for beam shaping purposes. The mirrors 108 can be arranged or mounted in mounts or the like in the housing 106 of the projection objective 105. The illumination system 103 also has corresponding optical elements or assemblies for beam shaping or beam guiding. However, these and also the housing of the illumination system 103 are not illustrated in greater detail.

In the example shown in FIG. 3, a separating structure 110 is inserted in the projection objective 105, a compartment 111 being formed via the separating structure within the projection objective, which compartment is substantially closed off spatially with respect to the remaining regions of the projection objective 105 and contains the optical elements 108′. The size of the passage opening 112 through which the projection beam passes is kept minimal in this case. It may be desirable to thermally insulate the compartment 111 from the remaining regions of the projection objective or to regulate the temperature of the separating structure 110, in particular to cool it.

FIG. 4 shows, in a first sectional illustration, a first variant for regulating the temperature of the separating structure 110. For this purpose, the separating structure 110 is provided with the tubular cooling coil 31, which is arranged on one surface of the separating structure 110; it is also conceivable for the cooling coil 31 to be arranged on both sides of the separating structure 110. The choice according to the disclosure of the cooling medium (not illustrated in the figure) that flows through the cooling coil 110, and the associated increase in the efficiency of the cooling make it possible firstly for the dimensions of the cooling coil 31 and the structural space involved to be kept small and secondly for the mechanical disturbances caused by the cooling in the overall system to be reduced.

FIG. 4a shows a view - rotated by 90° with respect to the illustration in FIG. 4—of the separating structure 110 with an exemplary meandering course of the cooling coil 31 around the passage opening 112 with inflow 120 and outflow 121. The course of the cooling coil 31 as shown in the figure ensures temperature regulation, in particular cooling, of the separating structure 110 in a manner that is spatially as uniform as possible.

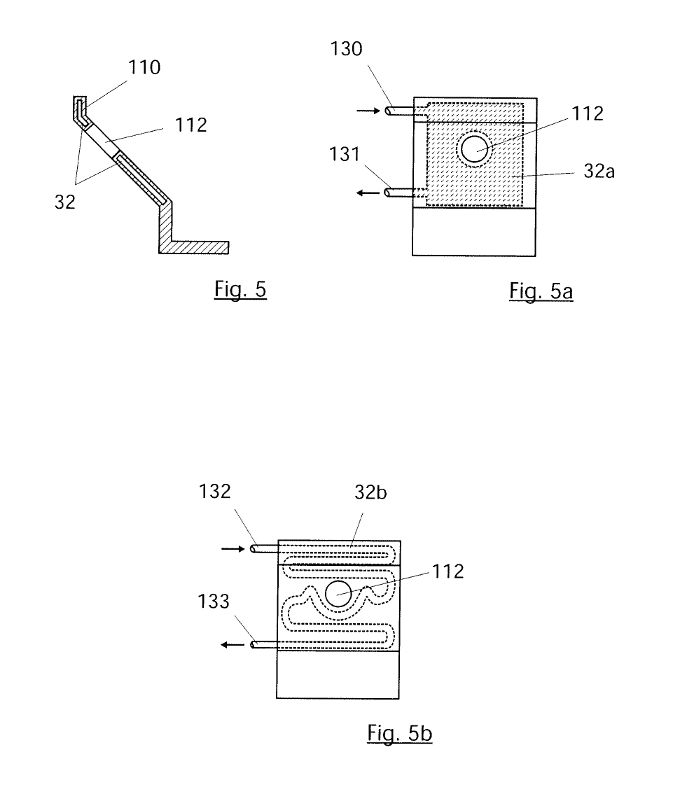

FIG. 5 shows a further possibility for regulating the temperature of the separating structure 110. In this case, the cooling medium is not guided in a cooling coil arranged on a surface of the separating structure 110, but rather is directed through cavities 32 integrated into the separating structure 110. In other words, the separating structure 110 is used firstly for spatially separating the compartment 111 and secondly for guiding the cooling medium.

FIGS. 5a and 5b show variants for the formation of the cavity 32. In the illustration in FIG. 5a, rotated by 90° with respect to FIG. 5, the cavity 32 is formed as a planar cavity 32a with the inflow 130 and the outflow 131, in which case the cooling medium can flow through the cavity 32a in the entirety thereof. This measure has the effect that very homogeneous regulation of the temperature of the separating structure 110 becomes possible. On account of the efficiency of the cooling device according to the disclosure, the volume content of the cavity 32a can be chosen to be so small that the mechanical stability of the separating structure 110 is not significantly impaired by the cavity 32a. Moreover, the substantially hollow formation of the separating structure 110 achieves the additional effect that the thermal isolation of the compartment 111 with respect to the remaining regions of the projection objective is improved even in those cases in which the cavity 32a is not filled by a liquid cooling medium.

FIG. 5b shows in an illustration analogous to FIG. 5a, a second variant for the formation of the cavity 32, in which the cavity 32 is realized as a channel 32b that runs in meandering fashion and is integrated into the separating element 110, with the inflow 132 and the outflow 133. This choice of the geometry of the cavity 32 further reduces the mechanical destabilization of the separating structure 110 owing to the presence of the cavity 32b.

In all the cases shown and discussed, the desired local temperature-regulating or cooling capacity can be adapted by the geometry of the medium-guiding structures such as e.g. the cooling coil 31 or the cavity 32 being chosen correspondingly.

The variants of the configuration of the medium-guiding structures that have been shown on the basis of the temperature regulation of a separating structure 110 can also be used for cooling other components of a projection exposure apparatus.

The disclosure can in particular also be used to regulate the temperature of, in particular cool, one or more of the mirrors 108 or else the housing 106 or regions of the housing 106.

The disclosure has been described in greater detail above on the basis of an EUV projection exposure apparatus. However, other embodiments are also possible. For example, certain features disclosed herein can be combined with and/or replaced by other features disclsed herein. Moreover, the disclosure can be employed in projection exposure apparatuses which operate in other wavelength ranges.

Other embodiments are in the claims.

What is claimed is:

1. An apparatus, comprising:
a component that forms at least part of a housing of the apparatus;
a cooling device thermally coupled to the component; and
a liquid cooling medium in the cooling device, the liquid cooling medium having a thermal conductivity of greater than 5 W/mK, wherein the apparatus is a projection exposure apparatus for semiconductor microlithography.

2. The apparatus according to claim 1, wherein the liquid cooling medium is a liquid metal or a liquid metal alloy.

3. The apparatus according to claim 2, wherein the liquid cooling medium comprises at least one element selected from from the group consisting of bismuth (Bi), lithium (Li), sodium (Na), potassium (K), rubidium (Rb), cesium (Cs), gallium (Ga), indium (In), tin (Sn) and mercury (Hg).

4. The apparatus according to claim 3, wherein the liquid cooling medium comprises between 55% and 75% gallium, between 18% and 24% indium, and between 14% and 18% tin.

5. The apparatus according to claim 1, wherein the component is an optical component.

6. The apparatus according to claim 1, wherein the component is part of an illumination system of the projection exposure apparatus.

7. The apparatus according to claim 1, wherein the component is part of a projection objective of the projection exposure apparatus.

8. The apparatus according to claim 1, further comprising a coil on the component, wherein the cool is in fliud communication with the cooling device.

9. The apparatus according to claim 9, wherein the component has a cavity configured to guide the liquid cooling medium.

10. The apparatus according to claim 9, wherein the cavity is a planar cavity.

11. The apparatus according to claim 9, wherein the cavity is a meandering channel.

12. The apparatus according to claim 1, wherein the projection exposure apparatus is an EUV projection exposure apparatus.

13. An apparatus, comprising:
a component that forms a compartment in the apparatus;
a cooling device thermally coupled with the component; and
a liquid cooling medium in the cooling device, the liquid cooling medium having a thermal conductivity greater than 5 W/mK,
wherein the apparatus is a projection exposure apparatus for semiconductor lithography.

14. The apparatus according to claim 13, wherein the liquid cooling medium is a liquid metal or a liquid metal alloy.

15. The apparatus according to claim 14, wherein the liquid cooling medium comprises at least one element selected from from the group consisting of bismuth (Bi), lithium (Li), sodium (Na), potassium (K), rubidium (Rb), cesium (Cs), gallium (Ga), indium (In), tin (Sn) and mercury (Hg).

16. The apparatus according to claim 15, wherein the liquid cooling medium comprises between 55% and 75% gallium, between 18% and 24% indium, and between 14% and 18% tin.

17. The apparatus according to claim 13, wherein the component is an optical component.

18. An apparatus, comprising:
a cooling device configured to cool components of the apparatus; and
a liquid cooling medium in the cooling device, the liquid cooling medium comprising between 55% and 75% gallium, between 18% and 24% indium, and between 14% and 18% tin,
wherein the apparatus is a projection exposure apparatus for semiconductor lithography.

19. The apparatus according to claim 18, wherein the component is an optical component.

20. The apparatus according to claim 18, wherein at least one of the following holds:
the component forms at least part of a housing of the apparatus; and
the component forms a compartment in the housing.
